(19) United States
(12) Patent Application Publication
(10) Pub. No.: US 2007/0222574 A1
(43) Pub. Date: Sep. 27, 2007

(54) Multi vehicle signal ground illumination indicator lamps for turn, hazard and brake signaling to enhance current methods of use

(76) Inventor: John Alan Courts, Monmouth, OR (US)

Correspondence Address: John Courts, 764 Dalke St. E, Monmouth, OR, 97361, US

(21) Appl. No.: 11/725,130

(22) Filed: Mar. 15, 2007

Related U.S. Application Data
(60) Provisional application No. 60/767,420, filed on Mar. 27, 2006.

(51) Int. Cl. B60Q 1/26

(52) U.S. Cl. 340/468

(57) ABSTRACT

This invention is designed to enhance the existing hazard signal, turn signal and brake signals of vehicles by placing mini spot lamps on four corners and or to the rear of vehicle, near or at existing signal lamp locations or on sides of vehicle, directing their light beams on a side angle towards the ground away from the vehicle, thus illuminating the indicated signal on the ground for other drivers to see the vehicles intentions. Important information from signal illumination on the ground is transmitted to a following driver several vehicles back, to either side or from an opposing direction of indicating vehicle, who's view may be blocked by interspersed vehicles between the indicating vehicle and the following or on coming driver. Many cases of rear end collisions and accidents are caused from following to close to the vehicle in front and not allowing the proper time to react to other vehicles braking or turning.

### FIELD OF THE INVENTION

This invention relates to the safety field of motor vehicles and their signaling and braking status, particularly to light illumination signals to the ground/roadway, which provides an early warning to other drivers, thus preventing accidents and collisions by enhancing the existing signaling methods of use.

### BACKGROUND OF THE INVENTION

This invention is designed to enhance the existing hazard signal, turn signal and brake signals of wheeled vehicles, by placing mini spot type lamps on four corners near or at existing signal lamp locations or on sides of vehicle, (IE: long bodied or trailer type) directing their light energy/beams with non limiting preference colors, such as, red color for brakes, amber or yellow for turn and hazards on a side angle towards the ground away from the vehicle, (so as not to interfere with other drivers vision or a “non blinding type of light” thus illuminating the indicated signal on the ground/roadway for other drivers to see the vehicles intentions. Important information from signal illumination on the ground is transmitted to a following driver several vehicles back, to either side or from an opposing direction of indicating vehicle, who's view may be blocked by interspersed vehicles between the indicating vehicle and the following or on coming driver. Many cases of rear end collisions and accidents are caused from following to close to the vehicle in front and not allowing the proper time to react to other vehicles braking or turning. This signaling enhancement will provide a “split second” of early warning that will prevent collisions and accidents. Also used to warn pedestrians of said vehicles intentions.

### DESCRIPTION

main components of the invention are miniature spot type lamps that project non limiting preference colors, such as red color for brake signaling and an amber or yellow color for turn and hazard signaling (these will very in size, voltage and wattage depending on vehicle type) placed on all four corners and or sides and or rear of vehicle. With four or more being turn or hazard and two or more being for brake signaling. A non limiting example for brake signaling, would illuminate a non limiting preference color, such as a red color beam to the ground to both sides and or rear of vehicle, providing vehicles that are several vehicles back that have no visual site of indicating vehicles brake lights, the driver can see the illumination on the ground ahead to the sides of vehicle using this method of signaling, thus giving an early warning as to the signaling drivers intentions and preventing a potential accident.

The same application works for the turn signals, they will illuminate a non limiting preference color, such as an amber or yellow color to the ground to the side angle of both front and rear of vehicle. This is most efficient when other vehicles are traveling in adjacent lanes and do not have full view of signaling vehicle. Also using the hazard signals with this application will greatly enhance the safety of surrounding motorist.

The signals are connected to existing vehicle electrical circuits, the brake signals are wired to the brake pedal circuit, therefore when the vehicle operator actuates the brake pedal, not only do the regular brake lights light, the corner lights cast a preference color, but not limited to a red light beam to each rear corner, illuminating the ground in the preference color red.

The necessary action required to achieve the operations of this invention are all activated by current actuation controls of vehicle pedals and switches. No additional thought or action is required from the operator of signaling vehicle.

Ideally, accidents that may include rear end collisions and side swipes will be greatly reduced by the use of this invention as compared to the known signal lights and methods of use. This invention can advantageously be employed for installation on new vehicles. This invention is also useful to retrofit existing vehicles including cars, trucks, motorcycles, bicycles, horse drawn vehicles and human powered vehicles.

It is clear to me that by using this invention to greatly enhance signaling and illuminating the signal to the ground around the signaling vehicle, many accidents and collisions will be prevented by allowing other drivers the extra time to react, more so at night than in the day.

It is well noted that the third brake light was a simple yet very helpful invention to prevent accidents, so much so, that all automobiles now come with a factory installed third brake light. My invention takes the vehicle signaling method to the next level, greatly reducing unnecessary accidents and collisions.

This method for signaling can be used to enhance only the turn signals and not the brake signals or vise versa or only the hazard signals can be used for warning of danger or a combination of the above. This can be used for any vehicle that needs registered with the department of motor vehicles, to include, but not limited to cars, trucks, tractors, trailers, motorcycles, three wheelers, bicycles and human powered vehicles.

This invention (either used by factory Oem application or by aftermarket add on) provides additional safety for vehicles passing and following in multiple traffic lanes, to indicate passing or stopping of another vehicle anticipated or intended or that change over to an inner or outer lane of a multiple lane road is to be made. In traffic, A passing or following driver may not see another vehicles turn or braking signal due to other vehicles blocking view, This invention provides an early warning signal via light beam/lamp source placed on all four corners and or to the rear of vehicle, Four or more, being turn and hazard and two or more, being brake signals, Either by Oem lighting or via aftermarket application, All operating from the existing electrical system, Illuminating the ground to the angled side, sides or rear of vehicle to warn others of vehicle intentions, Providing a safer environment and a decrease in accidents. Drivers behind other vehicles are more likely to see the illuminated signal with out actually seeing the vehicle, providing an early warning. In the case of using the hazard signal, the warning lights will illuminate the ground around the vehicle, providing a very clear and visible warning to other drivers.

### DETAILED DESCRIPTION

In addition to the drawings discussed below, this description describes one or more embodiments as illustrated in the drawings, however there is no intent to limit this disclosure to a single embodiment or embodiments disclosed herein, on the contrary, the intent is to cover all alternatives, modifications and equivalents included within the spirit and scope of this discloser and as defined by the appended claims.

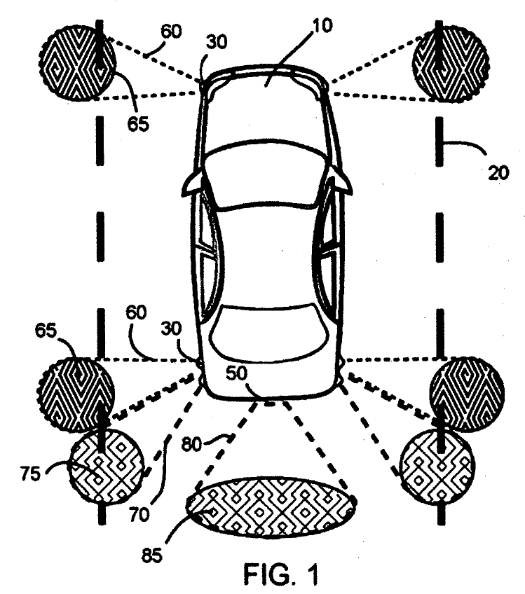

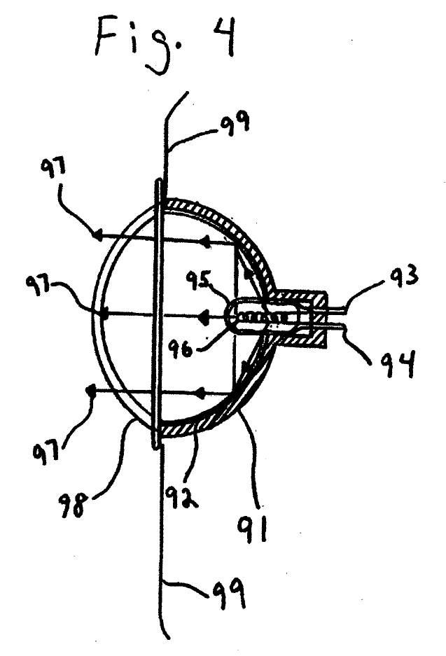

A vehicles turn and brake signaling is enhanced by this non limiting example. Additional turn and brake signal indicting spot lamps (IE: FIG. 4) are added to said vehicle. FIG. 1 illustrates the projection of ground illumination spot lamps (IE: FIG. 4) and non limiting positioning of said lamps. Light energy from lamps are directed down toward the ground/roadway, illuminating the ground for others to see drivers intentions. Lamps are fit into the body work, fenders, bumpers or designed into the vehicles lampwork of new production vehicles or can be mounted through after market bolt on design for vehicles that were in production before this invention.

The signaling spot lamps can very in size depending on vehicle and application. A non limiting preference would be a FIG. 4 spot lamp with a 2″ diameter dome shaped colored lens, powered with a 55 watt halogen bulb, mounted in the corner of vehicles bumper/fender region angled towards the side and down to ground/roadway.

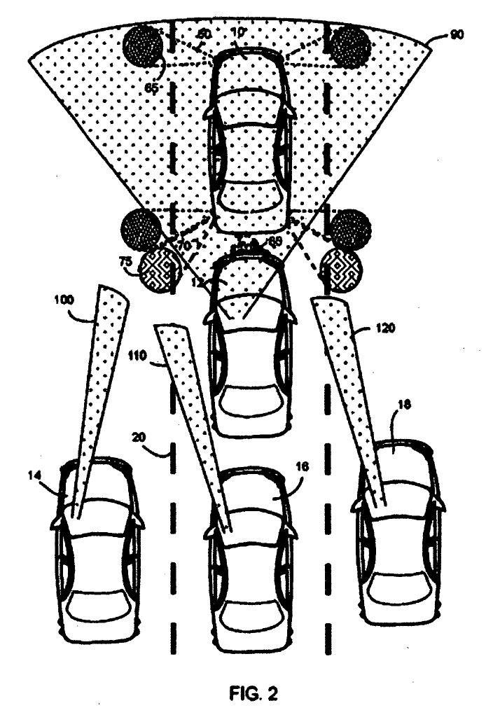

Halogen, laser, incandescent, xenon lamps are some non limiting examples of the types of bulbs that can accomplish the source of light. This discloser is not intended to be limited to a specific or particular type of lighting, additional types of illuminating light sources may be used, further more, the illumination of ground/roadway is not limited to any specific shape or size, yet very visible to other drivers as an early warning of intentions when signaling vehicle is not in sight due to blocked vision of other vehicles, as shown in FIG. 2.

All spot lamp ground/roadway illuminators described above are activated when driver of vehicle activates existing brake pedal or turn signals, no further input is required by driver, as all existing wiring is used in conjunction with the vehicles existing turn and brake signals.

FIG. 1 Illustrates all signaling spot lamps activated all at one time, this shows one non limiting example of a vehicle with hazard and brake signals on all at one instance, in a situation where a vehicle has stalled in the middle of roadway and is unable to move.

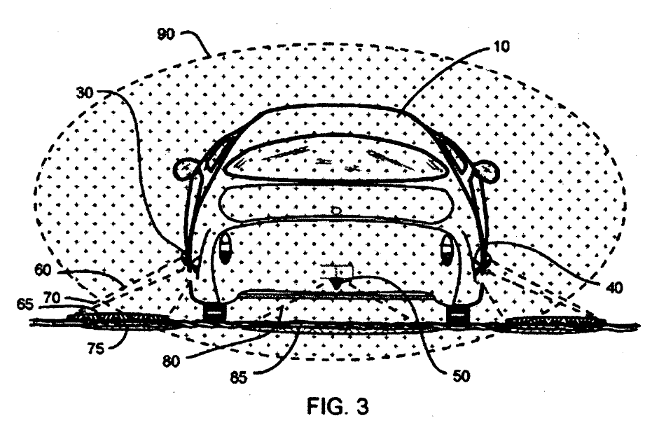

FIG. 3 Illustrates a non limiting example, where spot lamps 30,40,50 are angled to the side and or rear and down to ground/roadway, making certain that there is a non blinding light effect for surrounding motorist. FIG. 2 Illustrates a non limiting example where vehicles 12,14,16,18 have view of ground/roadway illumination 65 and 75 by signaling spot lamps 30,40,50. Note vehicle 16 cannot see with clarity vehicle 10 because vehicle 12 is blocking drivers view, yet driver of vehicle 16 has clear vision of 65 and 75 ground illuminations. Vehicles 14 and 18 have clear vision of ground illumination from vehicle 10 who is indicating a lane change, making drivers of 14 and 18 more aware of driver 10 intentions. Furthermore, daylight hours or during other times irrespective of road surface conditions, weather conditions or any other variables may diminish illumination visibility.

It is emphasized that the described embodiments and non limiting examples of this invention are merely possible examples of implementations set forth for a clear understanding of the principles disclosed herein. Modifications and variations can be made to the embodiment(s) and non limiting examples without departing substantially from the spirit and principles disclosed herein. All such modifications and variations are intended to be included herein within the scope of this discloser and protected by the following claims.

What is claimed is:

1. A vehicle brake and or turn signals enhancement spot lamps (IE: FIG. 4) direct light energy to the angled side and to the ground/roadway of said vehicle, comprising: one or more signal lamps being electronically coupled to signal indication circuits associated with vehicle, wherein one or more signals illuminate the ground/roadway when circuits are energized. Illumination color is non-limiting (IE: red for brakes, amber for turn/hazards). Light energy from spot lamps illuminate ground/roadway, adjacent lanes and lane of said vehicle with indicated signals.

2. That signal spot lamps are non limiting to location or angle on vehicle, position of lamps can be on front, rear, sides or under vehicle.

3. The vehicle brake and or turn signal lamps of claim 1, wherein the light source is comprised of one or more sources selected from the following: incandescent bulbs, halogen bulbs, laser, all being non limiting examples.

4. The vehicle brake and turn signal spot lamps of claim 1, wherein one or more light sources are electrically coupled to signal indication circuit in parallel to one or more brake and or turn signal lamps.

5. The vehicle spot lamps from claim 1, wherein the vehicle spot lamp indicators are units which are coupled to the vehicle.

6. A method for vehicle to signal brake and or turn signal illumination to the ground/roadway to an appending turn or lane change or braking status to warn other vehicles and pedestrians, comprising the steps of: activating vehicle brake or turn signal indication circuits; Illuminating the spot lamps, which in turn cast very visible light energy to the ground/roadway adjacent to, and or to the front and or rear of vehicle.

7. The method of claim 6, wherein the signals light source works in unison with the activated brake and or turn signal on vehicle.

8. A vehicles brake and or turn signal spot lamps, direct very visible and distinct light energy to the ground/roadway for other drivers and or pedestrians to see, comprising: one or more light sources electronically coupled to circuits associated with vehicle, wherein light sources illuminate the ground/roadway around vehicle with said signal in a non limiting color source as stated from claim 1.
